(19) United States
(12) Patent Application Publication
(10) Pub. No.: US 2025/0208750 A1
(43) Pub. Date: Jun. 26, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Eri HIRAKAWA, Kanagawa (JP)

(73) Assignee: FUJIFILM Business Innovation Corp., Tokyo (JP)

(21) Appl. No.: 18/740,061

(22) Filed: Jun. 11, 2024

(30) Foreign Application Priority Data
Dec. 20, 2023 (JP) 2023-215055

(51) Int. Cl. G06F 3/0482; G06F 3/0484

(52) U.S. Cl. CPC G06F 3/0482; G06F 3/0484

(57) ABSTRACT

An information processing system includes a processor and a memory. The processor is configured to: accept a creation instruction for setting information in which a setting value for executing processing is set for each of a plurality of function items; and if a display order to display the plurality of function items in the setting information for which the creation instruction has been accepted is changed from a preset display order, generate display order data based on the changed display order, and cause the display order data to be stored in the memory in association with the setting information.

### CROSS-REFERENCE TO RELATED APPLICATIONS

This application is based on and claims priority under 35 USC 119 from Japanese Patent Application No. 2023-215055 filed Dec. 20, 2023.

### BACKGROUND

### (i) Technical Field

The present disclosure relates to an information processing system, a non-transitory computer readable medium, and an information processing method.

### (ii) Related Art

Japanese Unexamined Patent Application Publication No. 2008-293495 discloses a driver device that enables a setting for a second function to be made in a period from the start of a setting operation for a first function executable in an image processing apparatus to the execution of a job of the first function.

Japanese Unexamined Patent Application Publication No. 2009-232316 discloses an image forming apparatus in which, even after an image-data processing instruction is issued to the image forming apparatus, the image forming apparatus can be made to process the image data in a state in which an image data attribute designated by the processing instruction is changed.

Japanese Unexamined Patent Application Publication No. 2021-033023 discloses an image processing apparatus in which the state of the image processing apparatus is detected and the order of arrangement of buttons for executing processing related to the detected state is changed to be higher on a menu screen.

### SUMMARY

Generally, when certain processing is executed in an information processing apparatus, there are cases where setting values of a plurality of function items used when executing the processing are changed from preset initial values. Since it is cumbersome to change the setting value of a certain function item from its initial value every time the certain processing is executed, a function has been proposed which enables creation and registration of new setting information in which the setting value of each function item is changed from its initial value. In a display screen for executing the certain processing, the plurality of function items are displayed in a preset display order. In this case, if the plurality of function items are to be displayed in the preset display order also in the newly created setting information, when the preset display order is changed, the display order of the plurality of function items in the new setting information will be also changed in conjunction therewith. Furthermore, in the newly created setting information, it may be desired to display the plurality of function items in a display order other than the preset display order. However, if the plurality of function items are to be always displayed in the preset display order when the newly created setting information is displayed, the display order of the function items in the newly created setting information cannot be managed for each setting information without being in conjunction with the preset display order.

Aspects of non-limiting embodiments of the present disclosure relate to an information processing system, a non-transitory computer readable medium, and an information processing method with which the display order of function items in newly created setting information can be managed for each setting information without being in conjunction with a preset display order.

Aspects of certain non-limiting exemplary embodiments of the present disclosure overcome the above disadvantages and/or other disadvantages not described above. However, aspects of the non-limiting exemplary embodiments are not required to overcome the disadvantages described above, and aspects of the non-limiting exemplary embodiments of the present disclosure may not overcome any of the disadvantages described above.

According to an aspect of the present disclosure, there is provided an information processing system including a processor and a memory, wherein the processor is configured to: accept a creation instruction for setting information in which a setting value for executing processing is set for each of a plurality of function items; and if a display order to display the plurality of function items in the setting information for which the creation instruction has been accepted is changed from a preset display order, generate display order data based on the changed display order, and cause the display order data to be stored in the memory in association with the setting information.

### BRIEF DESCRIPTION OF THE DRAWINGS

An exemplary embodiment of the present disclosure will be described in detail based on the following figures, wherein:

FIG. 1 is a diagram illustrating the configuration of an image forming system according to an exemplary embodiment of the present disclosure;

FIG. 2 is a block diagram illustrating a hardware configuration of an image forming apparatus in the exemplary embodiment of the present disclosure;

FIG. 3 is a block diagram illustrating a functional configuration of the image forming apparatus in the exemplary embodiment of the present disclosure;

FIG. 4 is a diagram illustrating an example of a home screen in the image forming apparatus of the exemplary embodiment of the present disclosure;

FIG. 5 is a diagram illustrating an example of a copy app screen which is displayed when a user selects an icon for a copy app;

FIG. 6 is a diagram illustrating an example of a screen for changing the display order of function items;

FIG. 7 is a diagram illustrating an example of function order data for the copy app;

FIG. 8 is a diagram illustrating an example of an operation screen when the user creates new setting information in which setting contents different from the setting contents of the copy app are set;

FIG. 9 is a diagram illustrating an example of a screen when creating setting information that is pinned;

FIG. 10 is a diagram illustrating an example of an operation screen when changing the display order of the function items of the setting information that is pinned;

FIG. 11 is a diagram illustrating an example of function order data for pinned setting information generated due to a change in the display order of the function items in the setting information that is pinned;

FIG. 12 is a diagram illustrating an example of an operation screen when selecting the pinned setting information thus generated;

FIG. 13 is a flowchart illustrating the flow of processing by a control section when the user selects the pinned setting information called “Intra-Section Circulated Document Copy” on the operation screen illustrated in FIG. 12;

FIG. 14 is a diagram illustrating the pinned setting information called “Intra-Section Circulated Document Copy” being displayed on an operation panel;

FIG. 15 is a diagram illustrating an operation menu icon of the setting information in which the display order of function items is to be changed, on a screen displaying the pinned setting information and a list of job history information;

FIG. 16 is a diagram illustrating an example of an operation screen that is displayed when the user has selected an operation menu “Change Pinning Setting” from among a plurality of operation menus displayed in the operation screen illustrated in FIG. 15; and

FIG. 17 is a diagram illustrating an example of an operation screen that is displayed when the user has operated an operation button “Change Order of Function List Displayed by Pinning” in the operation screen illustrated in FIG. 16.

### DETAILED DESCRIPTION

Next, exemplary embodiments of the present disclosure will be described in detail with reference to the drawings.

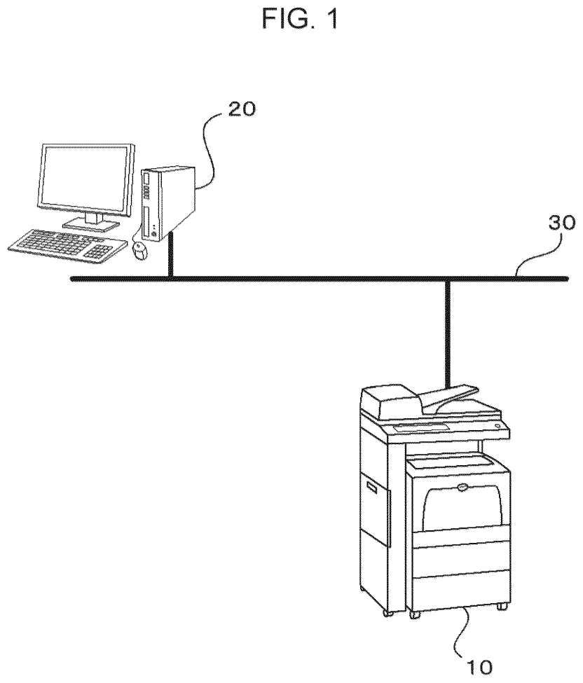

FIG. 1 is a diagram illustrating the configuration of an image forming system according to an exemplary embodiment of the present disclosure.

As illustrated in FIG. 1, the image forming system according to the exemplary embodiment of the present disclosure includes an image forming apparatus 10 and a terminal device 20 that are connected to each other via a network 30. The terminal device 20 generates print data and transmits the generated print data to the image forming apparatus 10 via the network 30. The image forming apparatus 10 accepts the print data transmitted from the terminal device 20, and outputs an image corresponding to the print data onto a sheet. The image forming apparatus 10 is a so-called multifunction peripheral having a plurality of functions, such as a print function, a scan function, a copy function, and a facsimile function.

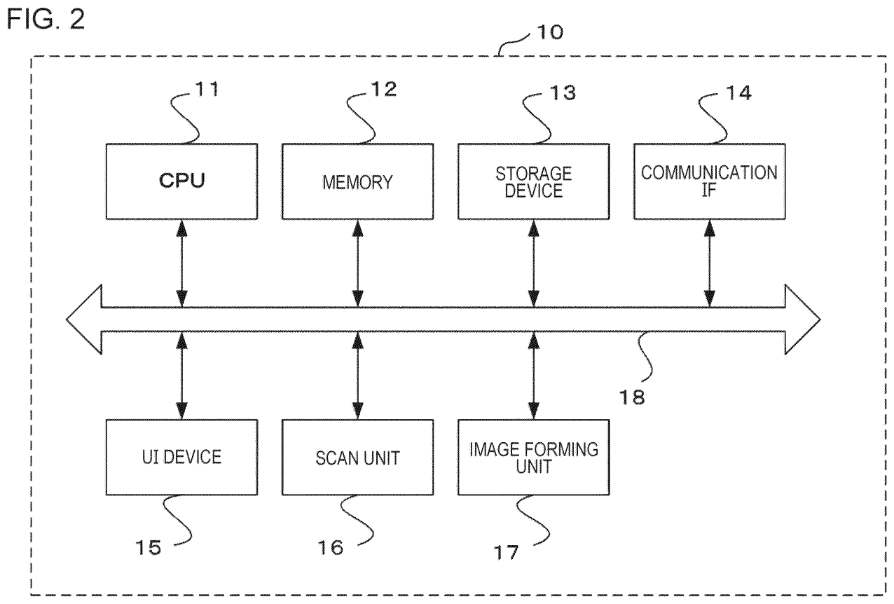

Next, a hardware configuration of the image forming apparatus 10 in the image forming system of the present exemplary embodiment is illustrated in FIG. 2.

As illustrated in FIG. 2, the image forming apparatus 10 includes a CPU 11, a memory 12, a storage device 13 such as a hard disk drive, a communication interface (abbreviated as IF) 14 that performs data transmission and reception with an external device or the like via the network 30, a user interface (abbreviated as UI) device 15 including a touch panel or a liquid crystal display and a keyboard, a scan unit 16, and an image forming unit 17. These components are connected to each other via a control bus 18.

The image forming unit 17 prints an image on a recording medium, such as a printing sheet, through the steps of, e.g., charging, exposure, development, transfer, and fixing.

The CPU 11 is a processor that executes predetermined processing based on a control program stored in the memory 12 or the storage device 13 to control the operation of the image forming apparatus 10. In the present exemplary embodiment, although the CPU 11 is described as reading and executing the control program stored in the memory 12 or the storage device 13, this is not a limitation. The control program may be provided in recorded form in a computer readable recording medium. For example, the program may be provided in recorded form in an optical disc, such as a compact disc read-only memory (CD-ROM) or a digital versatile disc read-only memory (DVD-ROM), or in recorded form in a semiconductor memory, such as a Universal Serial Bus (USB) memory or a memory card. The control program may also be acquired from an external device via a communication line connected to the communication interface 14. Furthermore, the control program may be provided as independent application software, or may be incorporated into the software of the image forming apparatus 10 as one function thereof.

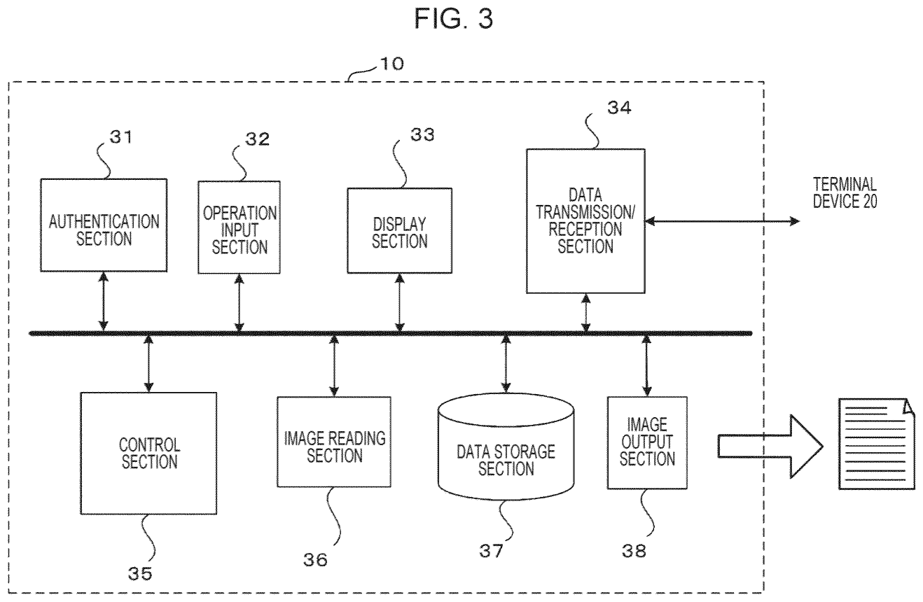

FIG. 3 is a block diagram illustrating a functional configuration of the image forming apparatus 10 implemented through execution of the above-described control program.

As illustrated in FIG. 3, the image forming apparatus 10 of the present exemplary embodiment includes an authentication section 31, an operation input section 32, a display section 33, a data transmission/reception section 34, a control section 35, an image reading section 36, a data storage section 37, and an image output section 38.

The authentication section 31 executes an authentication process for a user who attempts to use the image forming apparatus 10. The display section 33 is controlled by the control section 35 and displays various kinds of information to the user. The operation input section 32 inputs information on various operations performed by the user. The data transmission/reception section 34 transmits and receives data to and from an external device, such as the terminal device 20.

The image output section 38 outputs an image onto a recording medium, such as a printing sheet, based on control by the control section 35. The image reading section 36 reads a manuscript image from a manuscript that is set, based on control by the control section 35.

The control section 35 controls the overall operation of the image forming apparatus 10 and performs, e.g., control for generating print data based on a print job received from the terminal device 20 via the data transmission/reception section 34 and outputting the generated print data from the image output section 38, and control for reading the manuscript image by the image reading section 36. The data storage section 37 stores job history information indicating an execution history of various jobs executed by the control section 35, such as print jobs, scan jobs, copy jobs, and fax transmission jobs, as well as setting information in which a setting value for executing processing is stored for each setting item. Here, the job history information is history information of the processing contents of jobs executed in the past.

In the image forming apparatus 10 of the present exemplary embodiment, by selecting the job history information for execution, it is possible to re-execute a job having the same setting contents as a job executed in the past.

When the image forming apparatus 10 is used by the user to execute a job, new job history information is generated every time a job is executed. However, since the data storage area of the data storage section 37 is limited, the data storage area may have a deficiency if all the job history information is stored. Therefore, an upper limit is set such that, for example, only the latest 200 jobs are allowed to remain as job history information, and job history information that exceeds the upper limit is deleted in ascending order of date/time of execution.

Accordingly, in the image forming apparatus 10 of the present exemplary embodiment, a job history that is not desired to be deleted can be pinned so as not to be subject to deletion. A pinned job history is free from deletion and remains left even if an upper-limit number is exceeded by a job executed later.

Further, in addition to the case where the job history information when a job has been executed is pinned and saved as pinned setting information, it is also possible to register newly set setting information as pinned setting information. For example, setting contents which are likely to be repeatedly used in the future can be registered in advance as pinned setting information before a job, such as copying, is executed. By thus generating and registering the pinned setting information in advance, a job having desired setting contents can be executed just by selecting the pinned setting information when executing the job.

The thus created pinned setting information is not erased by the job history information which is generated when a job is executed, and remains saved as pinned setting information. In the following description, both the pinned setting information that is generated based on the job history information and the pinned setting information that is generated without executing a job will be described simply as pinned setting information or setting information that is pinned.

On a display screen for selecting and executing such pinned setting information, a plurality of function items are displayed in a preset display order. In this case, if the plurality of function items are to be displayed in the preset display order also in the newly created setting information, when the preset display order is changed, the display order of the plurality of function items in the new setting information will be also changed in conjunction therewith.

Furthermore, in the newly created setting information, it may be desired to display the plurality of function items in a display order other than the preset display order. However, if the plurality of function items are to be always displayed in the preset display order when the newly created setting information is displayed, the display order of the function items in the newly created setting information cannot be managed for each setting information without being in conjunction with the preset display order.

Thus, in the image forming apparatus 10 of the present exemplary embodiment, the processing described below is performed so that the display order of the function items in the newly created setting information can be managed for each setting information without being in conjunction with the preset display order.

First, an operation method for creating and saving pinned setting information in the image forming apparatus 10 of the present exemplary embodiment will be described with reference to the drawings.

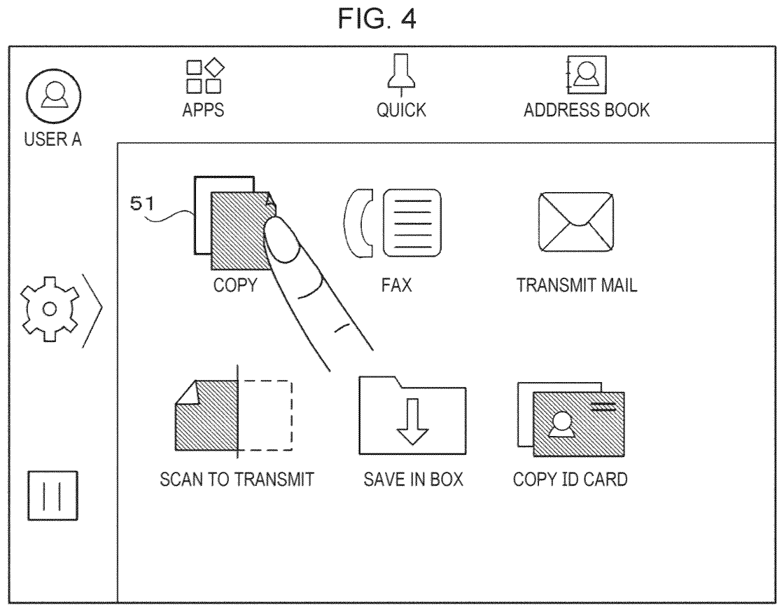

FIG. 4 illustrates an example of a home screen in the image forming apparatus 10 according to the present exemplary embodiment.

In the example of the home screen illustrated in FIG. 4, apps for executing various functions, such as copying, faxing, and scanning, are displayed on a touch panel. FIG. 4 illustrates the user selecting an icon 51 for the copy app to use the copy function.

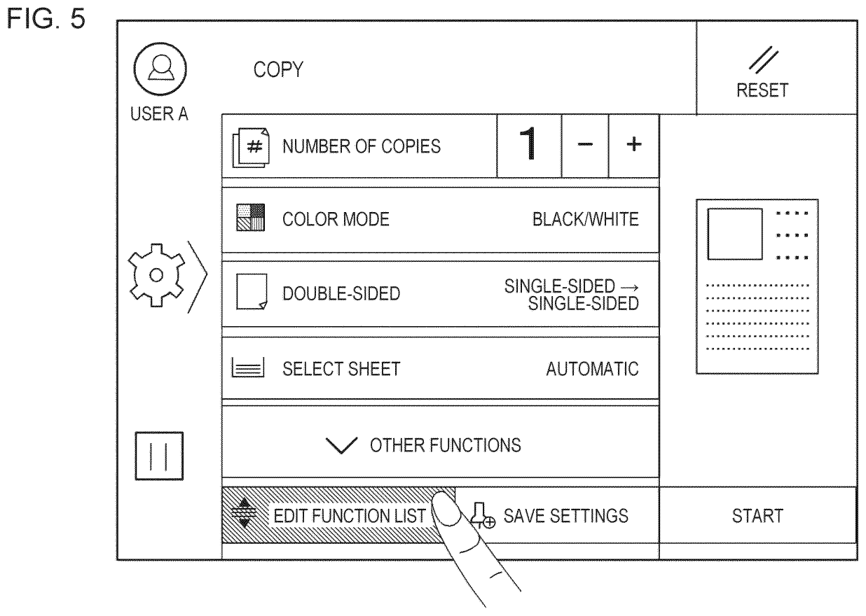

FIG. 5 illustrates an example of a copy app screen that is displayed when the icon 51 for the copy app is selected by the user. In the copy app screen illustrated in FIG. 5, the function items for the number of copies, color mode, double-sided, and sheet selection are displayed in a certain display order. When the user intends to change the setting value of a function item other than the function items currently being displayed, the user needs to operate an operation button called “Other Functions” to display the function item other than the function items currently being displayed. To change the setting value of a function item that is still not displayed, the user needs to scroll a plurality of function item lists to display the function item whose setting value is to be changed.

However, if the function item whose setting value is frequently changed by the user is displayed every time by the above-described method, the number of operations increases, which is inconvenient. Thus, it is made possible to change the display order of the plurality of function items when the copy app screen is displayed.

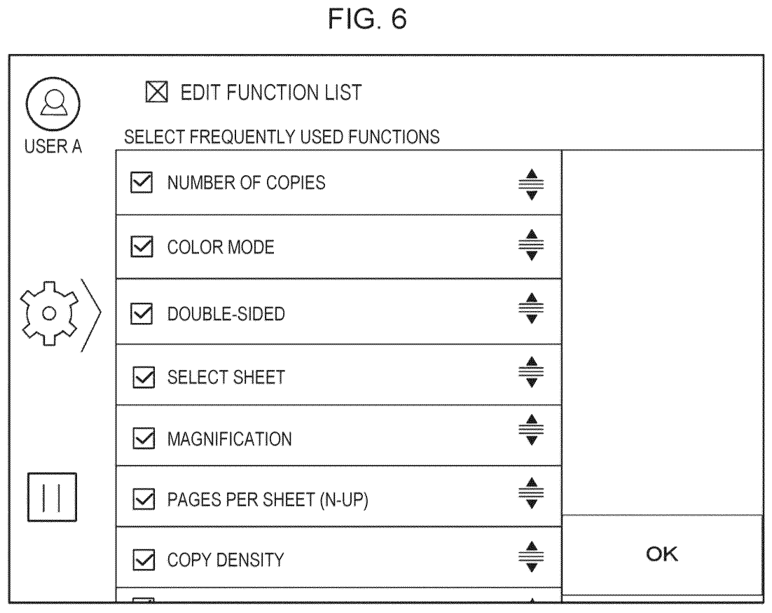

Specifically, when the user operates an operation button called “Edit Function List” on the copy app screen illustrated in FIG. 5, a screen for changing the display order of the function items is displayed, as illustrated in FIG. 6. When the user operates an OK button after changing the display order of the function items on the function list editing screen as illustrated in FIG. 6, the display order of the function items can be changed.

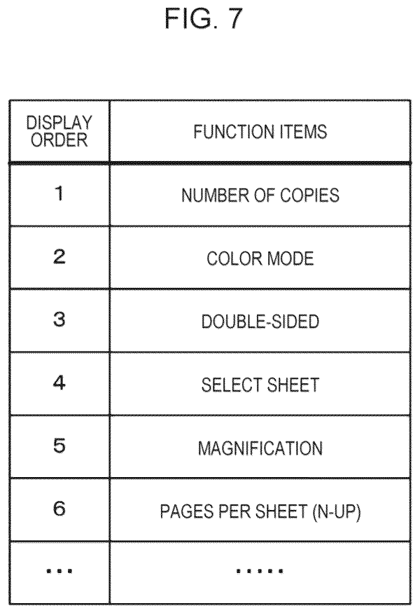

The changed display order of the function items is stored in the data storage section 37 as function order data, as illustrated in FIG. 7. In the following description, the display order data of the function items may be simply referred to as function order data.

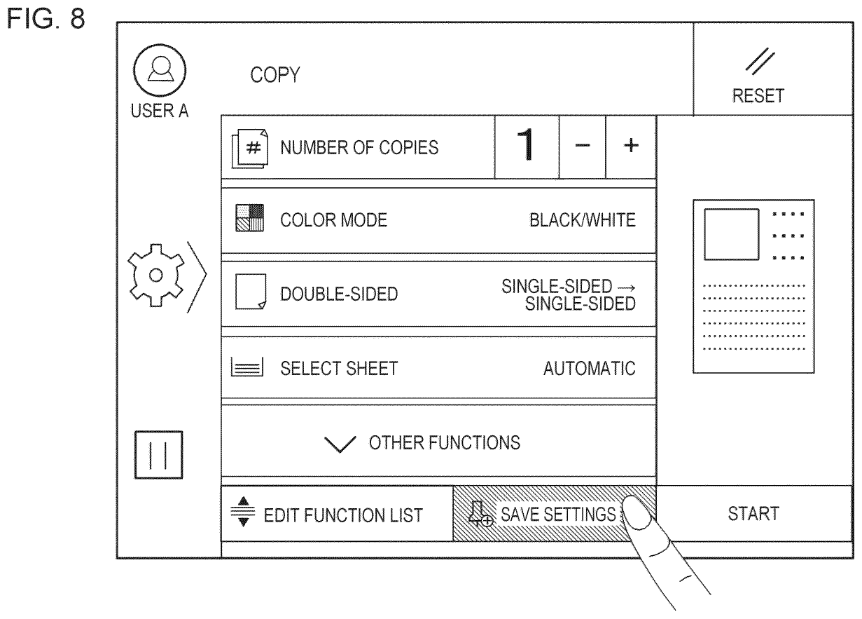

Next, FIG. 8 illustrates an operation screen when the user creates new setting information in which setting contents different from the setting contents of the copy app are set.

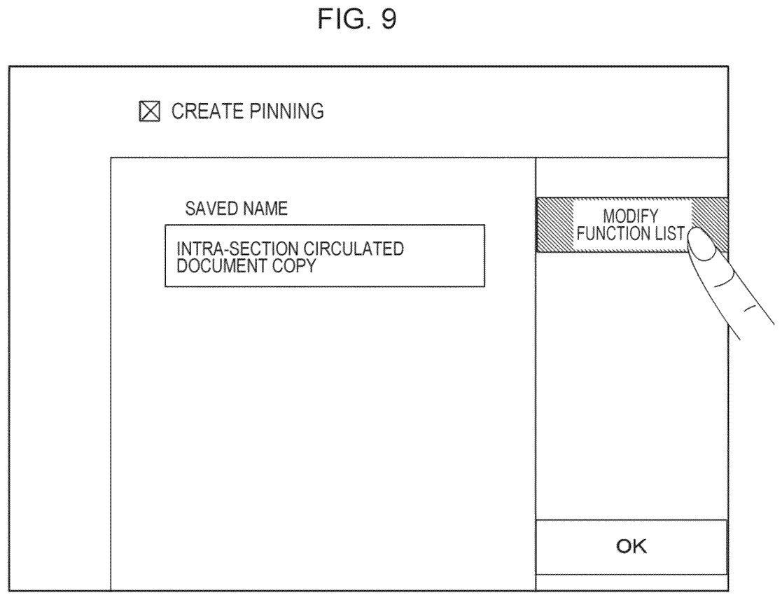

FIG. 8 illustrates the user operating an operation button called “Save Settings” on the copy app screen. If the user sets a frequently used setting value for each setting item and operates the operation button “Save Settings”, a screen as illustrated in FIG. 9 is displayed. FIG. 9 is a screen example where setting information that is pinned is created.

On the screen as illustrated in FIG. 9, when a save name is input and the OK button is operated, new setting information that is pinned is created. FIG. 9 illustrates an example case where setting information named “Intra-Section Circulated Document Copy” is created.

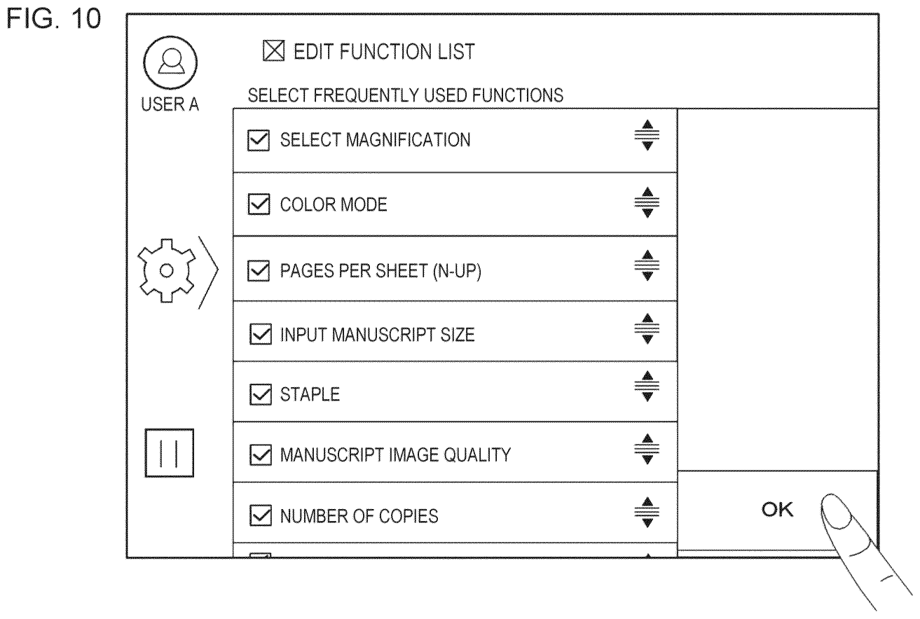

However, if the user operates the operation button called “Modify Function List” as illustrated in FIG. 9, a screen as illustrated in FIG. 10 is displayed, where the display order of the function items of the setting information being generated can be changed.

In the function list edit screen as illustrated in FIG. 10, after the display order of the function items is changed, when the OK button is operated, the display order of the function items of the setting information to be created can be changed. FIG. 10 illustrates a case where the display order of the setting items has been changed to Color Mode, Pages Per Sheet (N-Up), Input Manuscript Size, Staple, and so on, with the display order of the setting item “Select Magnification” placed at the top.

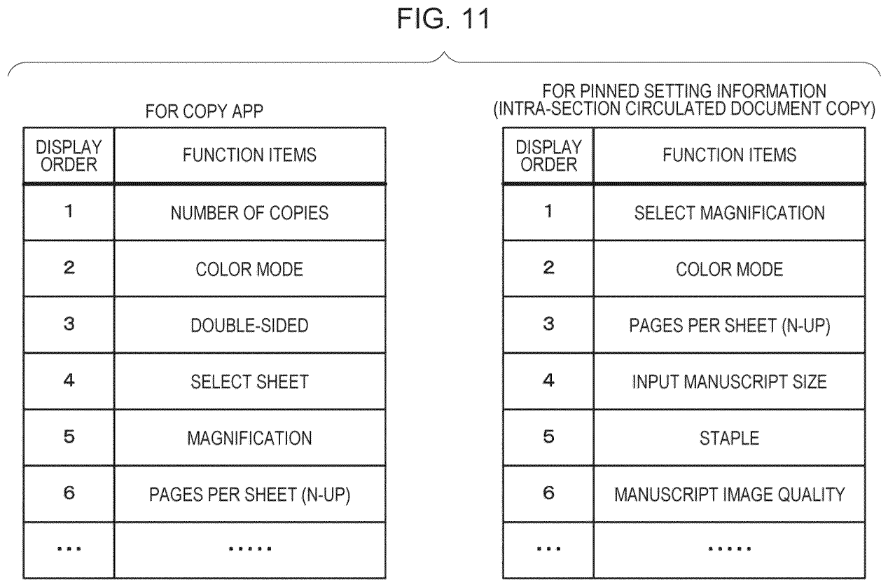

If the user sets, for the pinned setting information, a display order different from the display order of the setting items in the copy app, function order data for the pinned setting information different from the function order data for the copy app is newly generated. FIG. 11 illustrates an example of the function order data for the pinned setting information generated in this way.

Referring to the example of the function order data in FIG. 11, it is seen that function order data for the pinned setting information named “Intra-Section Circulated Document Copy” is created separately from the function order data for the copy app.

That is, in the image forming apparatus 10 of the present exemplary embodiment, the control section 35, upon accepting a creation instruction for new setting information of pinning in which a setting value for executing processing is set for each of a plurality of function items, if the display order to display the plurality of function items in the setting information of pinning for which the creation instruction has been accepted is changed from the preset display order, generates display order data based on the changed display order, and causes the display order data to be stored in the data storage section 37 in association with the setting information of pinning.

Then, when the setting contents of the pinned setting information stored in the data storage section 37 are displayed, if the display order data associated with the setting information exists, the control section 35 displays the plurality of function items in the display order based on the display order data associated with the setting information.

If the display order to display the plurality of function items in the setting information for which the creation instruction has been accepted is not changed from the preset display order, the control section 35 causes the setting information of which creation has been instructed to be stored in the data storage section 37 without generating the display order data.

Accordingly, when the setting contents of the setting information stored in the data storage section 37 are displayed, if the display order data associated with the setting information does not exist, the control section 35 displays the plurality of function items in the display order based on the preset display order data, i.e., the display order data for the copy app.

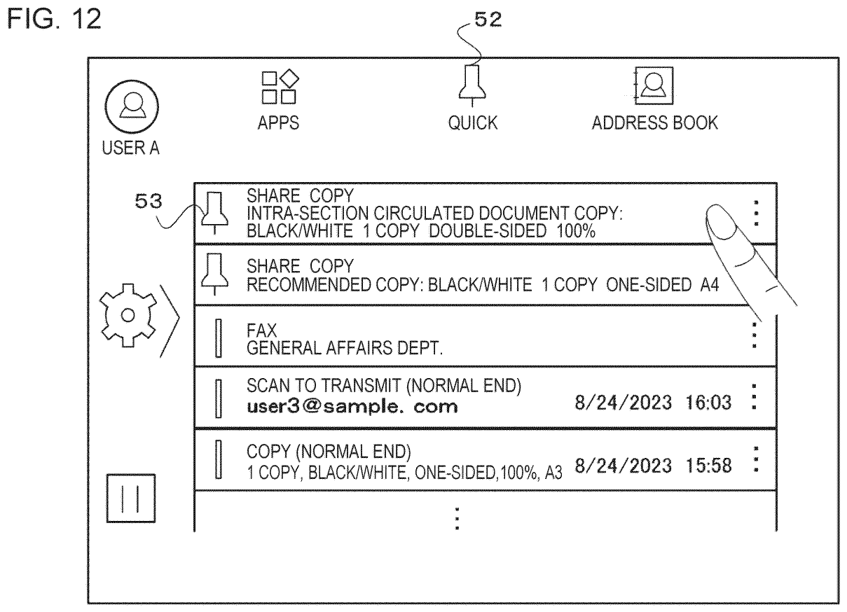

Next, FIG. 12 illustrates an example of an operation screen for selecting the pinned setting information generated in this way. The operation screen illustrated in FIG. 12 is displayed when an icon 52 named “Quick” is operated on the home screen.

In the operation screen illustrated in FIG. 12, a list of job history information on jobs executed in the past is displayed together with the pinned setting information. A pinning mark 53 indicating the pinned state is displayed for the pinned setting information.

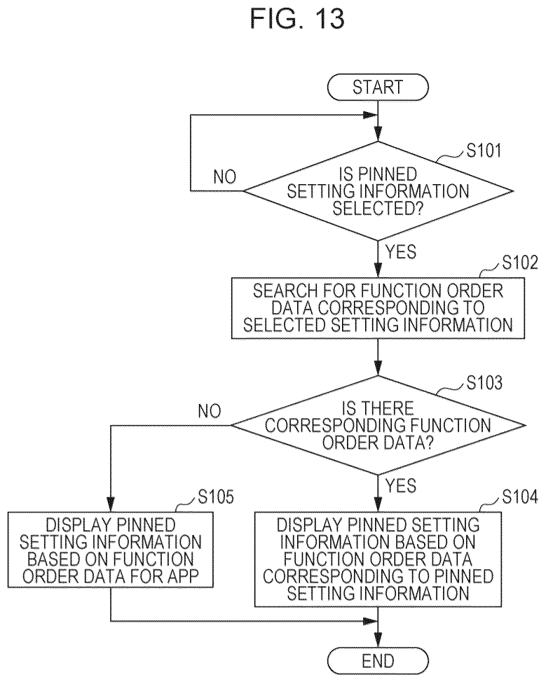

FIG. 13 illustrates a flowchart of the flow of processing performed by the control section 35 when the user selects the pinned setting information called “Intra-Section Circulated Document Copy” in the operation screen illustrated in FIG. 12.

If the setting information that is pinned is selected in step S101, the control section 35 searches the data storage section 37 for the function order data corresponding to the selected setting information in step S102. In step S103, the control section 35 determines whether the function order data corresponding to the selected setting information exists in the data storage section 37.

If it is determined in step S103 that the function order data corresponding to the selected setting information exists in the data storage section 37, the control section 35 displays, in step S104, the setting contents of the pinned setting information selected by the user, based on the function order data corresponding to the setting information that is pinned.

If it is determined in step S103 that the function order data corresponding to the selected setting information does not exist, the control section 35 displays, in step S105, the setting contents of the pinned setting information selected by the user, based on display order data set beforehand, that is, display order data for the copy app.

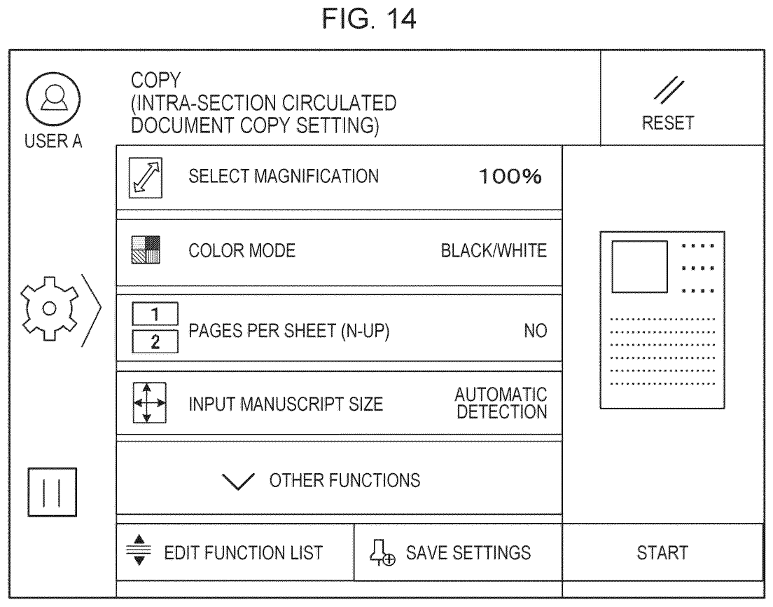

FIG. 14 illustrates the pinned setting information called “Intra-Section Circulated Document Copy” being thus displayed on the operation panel. With reference to FIG. 14, it is seen that the plurality of function items are displayed in the display order based on the function order data for the pinned setting information illustrated in FIG. 11.

Specifically, the plurality of function items are sequentially displayed in the display order of Color Mode, Pages Per Sheet (N-Up), Input Manuscript Size, and so on, with the display order of the setting item Select Magnification being placed at the top.

Even after the pinned setting information is created, the user may wish to change the display order of the plurality of function items in the created pinned setting information. Thus, even after the setting information is created based on the accepted creation instruction, the control section 35 accepts a change of the display order of the plurality of function items in the setting information.

The control section 35, upon accepting a change in the display order of the plurality of function items in the new setting information, if the display order data associated with the new setting information exists, updates the existing display order data with display order data reflecting the accepted change in the display order.

Here, the control section 35, upon accepting a change in the display order of the plurality of function items in the new setting information, if the display order data associated with the new setting information does not exist, newly generates display order data reflecting the accepted change in the display order, and causes the display order data to be stored in the data storage section 37 in association with the setting information.

Even when the display order of the plurality of function items of the certain pinned setting information is changed, there may be cases where it is desirable to leave the setting information before the change in the order of the plurality of function items. In such a case, the control section 35, upon accepting a change of the display order of the plurality of function items in the pinned setting information, may generate, separately from the original pinned setting information, setting information in which the display order of the plurality of function items is changed, and cause the generated setting information to be stored in the data storage section 37.

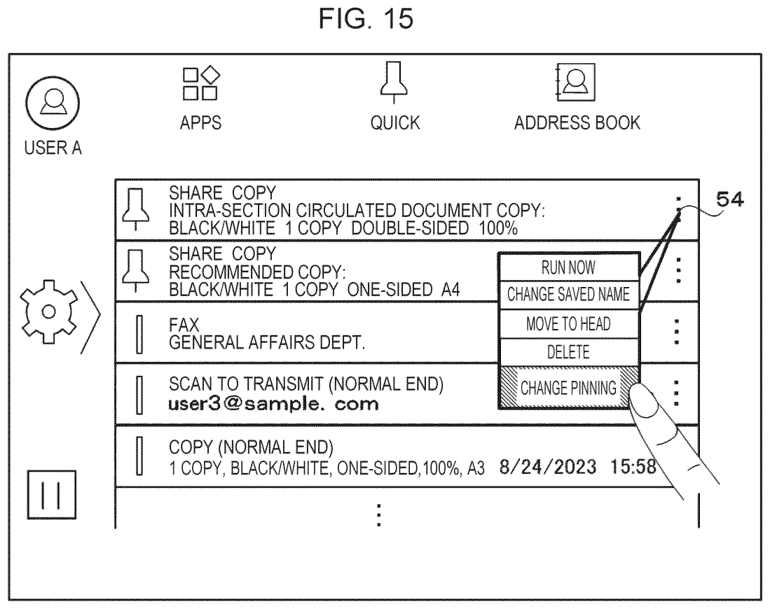

FIGS. 15 to 17 illustrate specific operation examples for changing the display order of the function items of the pinned setting information that has been created as described above.

First, on the screen displaying the pinned setting information and a list of job history information as illustrated in FIG. 15, the user operates an operation menu icon 54 of the setting information of which the display order of the function items is to be changed. Then, various operation menus for the setting information are displayed. Here, the user selects the operation menu “Change Pinning Setting” from the multiple operation menus displayed.

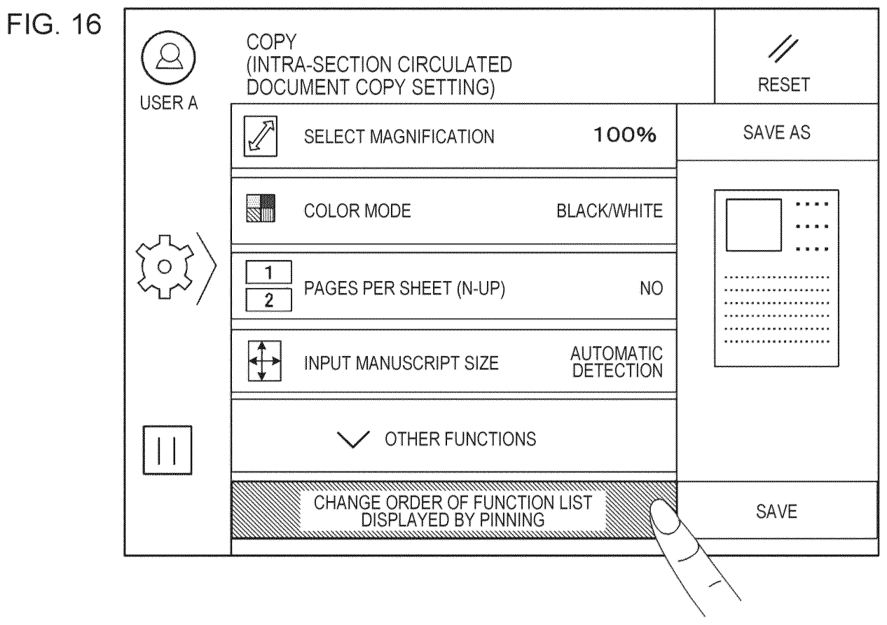

Then, an operation screen as illustrated in FIG. 16 is displayed on the operation panel. FIG. 16 illustrates the user further operating an operation button “Change Order of Function List Displayed by Pinning” in the operation screen.

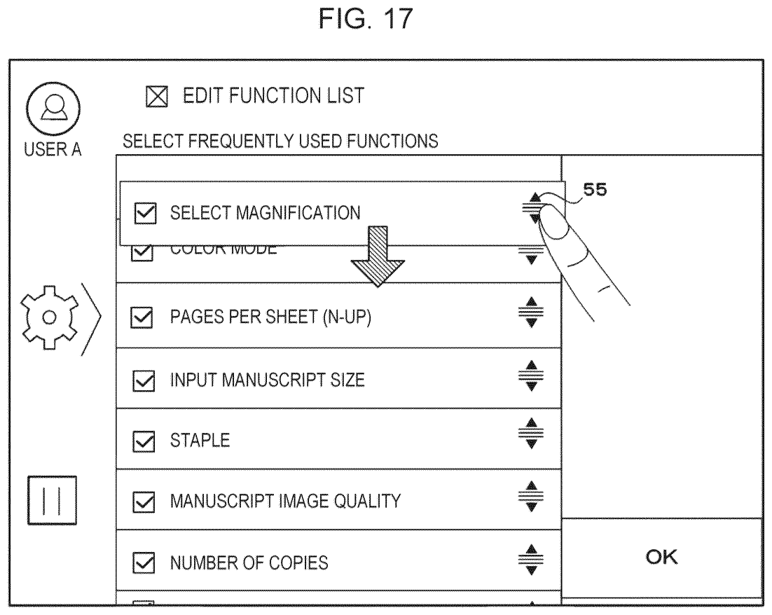

Then, an operation screen as illustrated in FIG. 17 is displayed on the operation panel, and the user can move a finger while pressing a rank change icon 55 displayed in a display field for a plurality of function items, thereby raising or lowering the display rank of each function item.

After the plurality of function items are rearranged in a desired display order, the user operates the OK button to finalize the display order. Then, the user returns to the operation screen illustrated in FIG. 16 and operates the operation button “Save”, whereby the formerly created function order data is updated. If the function order data associated with the pinned setting information is not yet generated at this time, the function order data associated with the setting information is newly generated and stored in the data storage section 37.

After the display order of the plurality of function items is rearranged, if the user operates an operation button called “Save As” on the operation screen illustrated in FIG. 16, the setting information of the plurality of function items whose display order has been rearranged is stored in the data storage section 37 as other pinned setting information with a name different from the original setting information. In this case, function order data associated with the pinned setting information is also newly generated and stored in the data storage section 37.

In the above exemplary embodiments, the processor refers to a processor in a broad sense, and includes general-purpose processors (for example, a CPU: Central Processing Unit) and dedicated processors (for example, a GPU: Graphics Processing Unit, an ASIC: Application Specific Integrated Circuit, an FPGA: Field Programmable Gate Array, and a programmable logic device).

The operation of the processor in the above exemplary embodiments may be performed not only by one processor but also by a plurality of processors existing at physically separated positions operating in cooperation with each other. In addition, the order of the operations of the processor is not limited to the order described in the exemplary embodiments described above but may be changed as appropriate.

A “system” in the present exemplary embodiment includes both a system composed of a plurality of apparatuses and a system composed of a single apparatus.

### Modifications

While the above exemplary embodiment has been described using the case where the present disclosure is applied to the image forming apparatus 10, the present disclosure is not limited to such a case. The present disclosure can be similarly applied to an information processing apparatus and an information processing system capable of storing setting information in which a setting value for executing processing is set for each of a plurality of function items and executing processing based on the stored setting information.

### Appendix

(((1)))

An information processing system comprising:
a processor; and
a memory,
wherein the processor is configured to:
   accept a creation instruction for setting information in which a setting value for executing processing is set for each of a plurality of function items; and
   if a display order to display the plurality of function items in the setting information for which the creation instruction has been accepted is changed from a preset display order, generate display order data based on the changed display order, and cause the display order data to be stored in the memory in association with the setting information.
      (((2)))

The information processing system according to (((1))), wherein the processor is configured to, when setting contents of the setting information stored in the memory are displayed, if the display order data associated with the setting information exists, display the plurality of function items in a display order based on the display order data associated with the setting information.

(((3)))

The information processing system according to (((1))) or (2))), wherein the processor is configured to, if the display order to display the plurality of function items in the setting information for which the creation instruction has been accepted is not changed from the preset display order, cause the setting information of which creation has been instructed to be stored in the memory without generating display order data.

(((4)))

The information processing system according to (((3))), wherein the processor is configured to, when setting contents of the setting information stored in the memory are displayed, if the display order data associated with the setting information does not exist, display the plurality of function items in a display order based on the preset display order data.

(((5)))

The information processing system according to any one of (((1))) to (((4))), wherein the processor is configured to accept a change in the display order of the plurality of function items in the setting information even after the setting information is created based on the accepted creation instruction.

(((6)))

The information processing system according to (((5))), wherein the processor is configured to, upon accepting a change in a display order of a plurality of function items in new setting information, if display order data associated with the new setting information exists, update the existing display order data with display order data reflecting the accepted change in the display order.

(((7)))

The information processing system according to (((5))), wherein the processor is configured to, upon accepting a change in a display order of a plurality of function items in new setting information, if display order data associated with the new setting information does not exist, newly generates display order data reflecting the accepted change in the display order, and cause display order data to be stored in the memory in association with the setting information.

(((8)))

The information processing system according to (((5))), wherein the processor is configured to, upon accepting a change in a display order of a plurality of function items in new setting information, generate, separately from the new setting information, setting information in which the display order of the plurality of function items is changed, and cause the setting information to be stored in the memory.

(((9)))

A program causing a computer to execute a process comprising:
accepting a creation instruction for setting information in which a setting value for executing processing is set for each of a plurality of function items; and
if a display order to display the plurality of function items in the setting information for which the creation instruction has been accepted is changed from a preset display order, generating display order data based on the changed display order, and storing the display order data in association with the setting information.
   (((10)))

An information processing method comprising:
accepting a creation instruction for setting information in which a setting value for executing processing is set for each of a plurality of function items; and
if a display order to display the plurality of function items in the setting information for which the creation instruction has been accepted is changed from a preset display order, generating display order data based on the changed display order, and storing the display order data in association with the setting information.

What is claimed is:

1. An information processing system comprising:
a processor; and
a memory,
wherein the processor is configured to:
accept a creation instruction for setting information in which a setting value for executing processing is set for each of a plurality of function items; and
if a display order to display the plurality of function items in the setting information for which the creation instruction has been accepted is changed from a preset display order, generate display order data based on the changed display order, and cause the display order data to be stored in the memory in association with the setting information.

2. The information processing system according to claim 1, wherein the processor is configured to, when setting contents of the setting information stored in the memory are displayed, if the display order data associated with the setting information exists, display the plurality of function items in a display order based on the display order data associated with the setting information.

3. The information processing system according to claim 1, wherein the processor is configured to, if the display order to display the plurality of function items in the setting information for which the creation instruction has been accepted is not changed from the preset display order, cause the setting information of which creation has been instructed to be stored in the memory without generating display order data.

4. The information processing system according to claim 3, wherein the processor is configured to, when setting contents of the setting information stored in the memory are displayed, if the display order data associated with the setting information does not exist, display the plurality of function items in a display order based on preset display order data.

5. The information processing system according to claim 1, wherein the processor is configured to accept a change in the display order of the plurality of function items in the setting information even after the setting information is created based on the accepted creation instruction.

6. The information processing system according to claim 5, wherein the processor is configured to, upon accepting a change in a display order of a plurality of function items in new setting information, if display order data associated with the new setting information exists, update the existing display order data with display order data reflecting the accepted change in the display order.

7. The information processing system according to claim 5, wherein the processor is configured to, upon accepting a change in a display order of a plurality of function items in new setting information, if display order data associated with the new setting information does not exist, generates display order data reflecting the accepted change in the display order, and cause display order data to be stored in the memory in association with the setting information.

8. The information processing system according to claim 5, wherein the processor is configured to, upon accepting a change in a display order of a plurality of function items in new setting information, generate, separately from the new setting information, setting information in which the display order of the plurality of function items is changed, and cause the setting information to be stored in the memory.

9. A non-transitory computer readable storage medium storing a program for causing a computer to execute a process comprising:
accepting a creation instruction for setting information in which a setting value for executing processing is set for each of a plurality of function items; and
if a display order to display the plurality of function items in the setting information for which the creation instruction has been accepted is changed from a preset display order, generating display order data based on the changed display order and storing the display order data in association with the setting information.

10. An information processing method comprising:
accepting a creation instruction for setting information in which a setting value for executing processing is set for each of a plurality of function items; and
if a display order to display the plurality of function items in the setting information for which the creation instruction has been accepted is changed from a preset display order, generating display order data based on the changed display order and storing the display order data in association with the setting information.
